(19) United States
(12) Patent Application Publication
(10) Pub. No.: US 2008/0218501 A1
(43) Pub. Date: Sep. 11, 2008

(54) Display illumination system and method

(76) Inventor: Michael B. Diamond, Los Gatos, CA (US)

Correspondence Address: NVIDIA C/O MURABITO, HAO & BARNES LLP, TWO NORTH MARKET STREET, THIRD FLOOR, SAN JOSE, CA, 95113, US

(21) Appl. No.: 12/005,960

(22) Filed: Dec. 28, 2007

Related U.S. Application Data
(62) Division of application No. 10/448,823, filed on May 30, 2003.

(51) Int. Cl. G06F 3/038

(52) U.S. Cl. 345/207

(57) ABSTRACT

The present invention provides automatic adjustments to an image presentation based upon changes in ambient light. The adjustments can be made to the back-lighting and/or the pixel data. The ambient lighting can be measured by a variety of sensors (e.g., a digital camera) from a variety of orientations. For example, the sensor can be directed away from the display (e.g., towards the user) or the sensor can be directed towards the display (e.g., from an angle comparable to the users view). In one exemplary implementation a graphics control system utilizes real time ambient light sampling input to calibrate a back-light illumination level and/or pixel illumination levels. The present invention can be implemented in a variety of devices (e.g., laptop, PDA, cell phone, headsup display, etc.).

### RELATED APPLICATIONS

This Application claims the benefit and priority of and is a Divisional of U.S. patent application Ser. No. 10/448,823, entitled “A Display Illumination System and Method” (Attorney Docket No. NVID-P000633), filed on May 30, 2003, which is incorporated herein by this reference.

### FIELD OF THE INVENTION

The present invention relates to the field of electronic display devices. More particularly, the present invention relates to a system and method for making adjustments to compensate for environmental changes when engaging in image display activities.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data in most areas of business, science, education and entertainment. Frequently, these electronic technologies are utilized to convey information. Displaying information in a visual presentation is usually a convenient and effective method of conveying the information. However, poor image quality and a number of interfering environmental conditions can adversely effect or impede information presentation and user comprehension.

Typically, the primary function of a display screen is to provide a clear and readily viewable presentation to a user. However, there are numerous environmental conditions that can have a significant impact on the perceptibility of the presentation. One of the most important factors affecting a users ability to easily perceive the shapes or images of a presentation is appropriate illumination of the display screen. For example, ambient light can often have significant impacts on the clarity of a display screen presentation.

The amount of ambient light that illuminates a display can determine the perceptibility of an image presented on a display. Ambient light is often insufficient to provide adequate illumination of a display screen, for example at night or in dark locations. Relative changes in the ambient lighting conditions can also impact ability to perceive a display image. For example, changing ambient lighting conditions associated with lights being turned on, off or dimmed often impact a users view. Changes in lighting provided by natural sources can also have detrimental affects such as changes in sun light when the sun rises to an apex and then sets, window shades are opened or closed or a cloud passes by temporarily reducing the sun light. The change in ambient illumination can be the result of the display orientation changing with respect to the source of the ambient light. Traditional displays do not typically take such real time ambient light changes into consideration when displaying an image.

Some conventional displays attempt to statically address reduced ambient lighting conditions. Traditional attempts at providing adequate illumination usually include self contained lighting provisions (e.g., a back-light) that provide a constant light level during device operation. Conventional display systems typically focus on achieving a predetermined particular illumination without regard for environmental conditions. For example, a back-light system is set to provide a particular output of illumination regardless of whether the ambient lighting is sufficiently bright or not. However, back-light systems often consume a relatively large portion of the power consumed by a system.

As the components required to build display devices have reduced in size, new categories of mobile devices have emerged. Even though some of these devices are very small, they typically provide diverse functionality and their capabilities are constantly increasing. Numerous hand held devices (e.g., cellular phones, lap top and palm top computer systems, etc.) are becoming more prolific and are utilized by a widespread section of society. Display capabilities of handheld devices are becoming increasingly meaningful and due to the relatively small size of the display in a handheld device it is important for the presentation to be clear and well illuminated. Typically, the mobility and compactness of the devices typically limits the power supply and it is important to effectively utilize the resulting limited light emissions.

The illumination uniformity of an image display also often has a significant impact on the perceptibility of a presentation. Ambient lighting conditions can alter the perceived uniformity of a display. For example, a shadow may be cast on a portion of a display causing that portion of the display to appear darker relative to other portions. Traditional computer display illumination techniques often provide back-lighting from a single source spread across the display without concern for environmental conditions. While the backlight illumination may get distributed evenly throughout a display, some areas of a display screen often appear significantly lighter or darker than other areas due to environmental conditions that impact one portion of the screen differently than another.

### SUMMARY

The present invention is a dynamic and adaptive system and method that provide illumination adjustments to an image display presentation corresponding to ambient lighting conditions around the display. By adjusting the presentation (e.g., adjusting back-lighting and/or pixel data) the present invention provides an improved image quality as the ambient lighting conditions change (e.g., moving the device) and also facilitates power conservation (e.g., by reducing back-lighting when not required). The improved image quality facilitates a users ability to easily perceive the shapes or images of a presentation. In one embodiment the present invention includes a feedback “mechanism” that directs automatic adjustments to an image presentation based upon changes in the ambient light. The adjustments can be made to the back-lighting and/or the pixel data. In one exemplary implementation, a vertex map or alternatively a brightness map is overlaid on the display image to compensate for changes in ambient light conditions.

The invention is applicable to a variety of display or presentation devices. It is also readily adaptable for utilization with an assortment of sensors capable of monitoring the ambient light environment of the display device (e.g., a digital camera). The ambient lighting can also be monitored from a variety of orientations. The sensor can be directed away from the display (e.g., towards the user) or the sensor can be directed towards the display (e.g., from an angle comparable to the users view). In one exemplary implementation, a graphics control system utilizes real time ambient light sampling input to calibrate the image presentation automatically. Ambient light measurements can be averaged over a period of time and/or space. For example, ambient light can be sampled or measured at a predetermined rate (e.g., 30, 60, etc. frames a second) and/or from a variety of multi spot locations. In one embodiment, adjustments in illumination are made based upon an average of those measurements or readings. The present invention is able to calibrate the adjustments to make a rapid yet smooth transition in the presentation.

### DESCRIPTION OF THE DRAWINGS

The accompanying drawings, which are incorporated in and form a part of this specification, illustrate embodiments of the invention and, together with the description, serve to explain the principles of the invention. The drawings referred to in this specification should be understood as not being drawn to scale except if specifically noted.

FIG. 1A is a block diagram of image presentation system in accordance with one embodiment of the present invention.

FIG. 1B is an illustration of an image presentation system comprising multiple sensors in accordance with one embodiment of the present invention.

FIG. 1C is an illustration of one embodiment of an image presentation system in which light sensors sense ambient light in conical spaces.

FIG. 2 is a block diagram of computer system, one embodiment of a computer system upon which the present invention can be implemented.

FIG. 3A is a block diagram of one embodiment of a present invention display presentation adjustment system in which the an ambient light sensor array is located behind a display pixel array.

FIG. 3B is one exemplary illustration of a shadow imposed upon display device without adjustment by the present invention.

FIG. 3C is another exemplary illustration of a shadow imposed upon display device without adjustment by the present invention.

FIG. 3D is a tabular representation of one exemplary relationship between the rate at which ambient light conditions change and the rate at which compensating adjustments are made to the display.

FIG. 4 is a flow chart of display presentation adjustment method 400, one embodiment of the present invention.

FIG. 5A is an illustration of one exemplary configuration of light sensors in accordance with one embodiment of the present invention.

FIG. 5B is an illustration of another exemplary configuration of present invention sensors in wells in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

The present invention is directed towards adjusting illumination of a display image in response to varying ambient environmental lighting conditions. In one embodiment, a digital camera senses the ambient light around a display screen and a control component adjusts the display illumination. For example, a digital camera and/or multiple digital cameras can sense the ambient light in multiple regions of space (e.g., around a display screen) and an illumination adjustment can be made to correspond to a measurement from each individual region of space or an average of the measurements from the different regions. In one exemplary implementation, illumination from a back-light is adjusted and in an alternate implementation the illumination characteristics of a pixel are adjusted. The illumination is increased for relatively dark ambient lighting conditions and reduced for relatively light ambient lighting conditions. Thus, appropriate illumination for viewing the image is provided in a manner that facilitates increased user perceptibility of a presentation during changing ambient light conditions. The present invention also facilitates increased power conservation when ambient light conditions permit (e.g., are bright enough to view a screen with reduced assistance from back lighting).

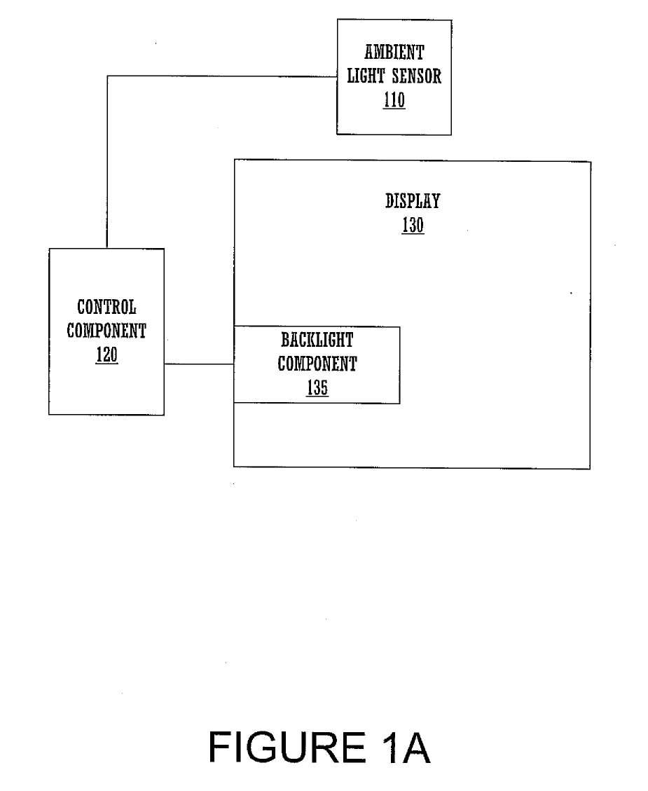

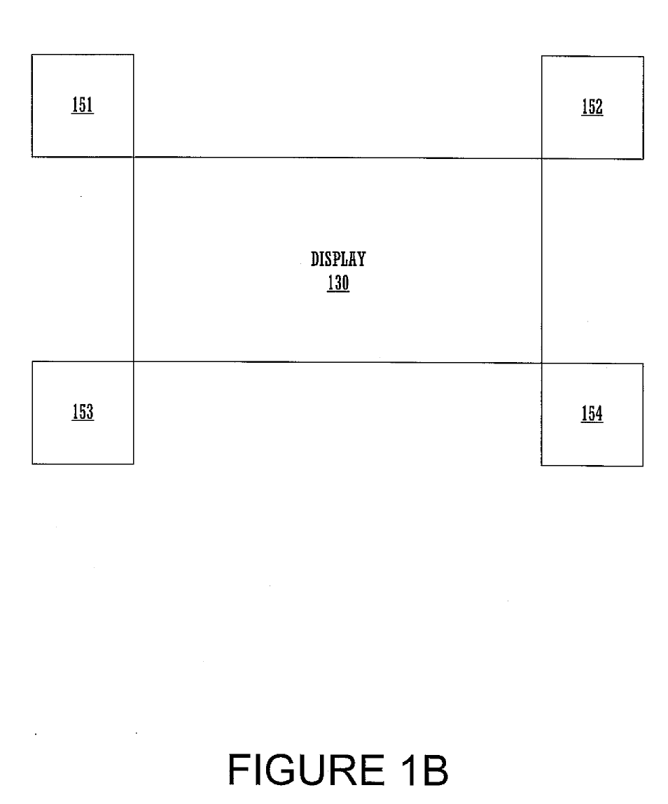

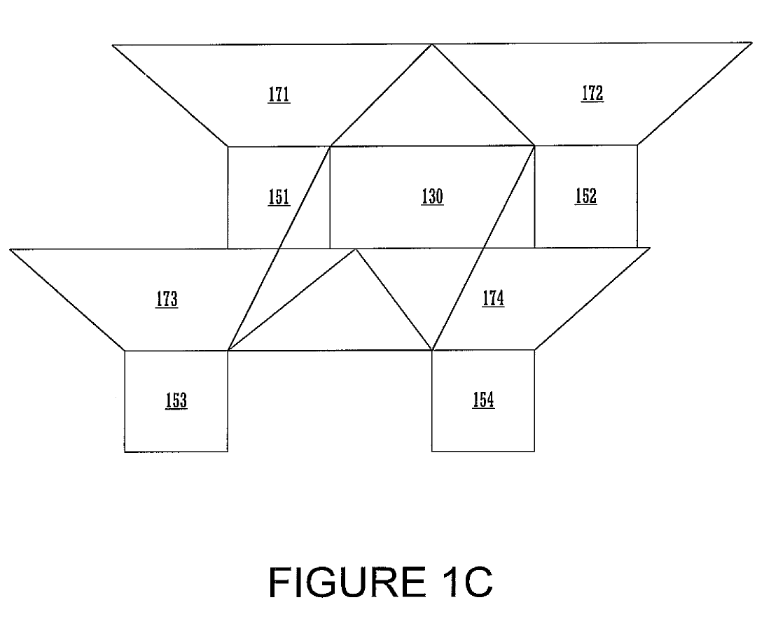

FIG. 1A is a block diagram of image presentation system 100, one embodiment of the present invention. Image presentation system 100 comprises an ambient light sensing component 110 (e.g., a digital camera), a control component 120, and display component 130. Ambient light sensing component 110 is communicatively coupled to control component 120 which is communicatively coupled to display component 130. The components of image presentation system 100 cooperatively operate to present an image with adjustments to compensate for environmental conditions including changes in ambient light. Ambient light sensing component 110 senses (e.g., measures) the ambient light condition on an image. The measurements can be differentiated by spatial region or averaged over multiple spatial regions. In one embodiment, ambient light sensing component 110 senses ambient lighting photogenic levels and returns a voltage corresponding to photon level read. Depending on the scale of that voltage, relative changes in the ambient illumination are analyzed. Control component 120 adjusts the illumination of the image based upon the ambient light condition. Display component 130 displays the image. In one exemplary implementation, display component 130 is a cathode ray tube (CRT) device and in an alternate embodiment display component 130 is a field emission display (FED) device.

Ambient light sensing component 110 can have a variety of implementations. In one embodiment, ambient light sensing component 110 is a digital camera sensing component. For example, a digital camera sensing component can include a filter (e.g., an intelligent filter) that monitors the ambient light quality the cameras senses. In one exemplary implementation, a digital camera sensing component measures ambient light illumination of the image provided from a source other than the presentation system. The illumination is the result of photons from the other source striking or hitting the presentation (e.g., the surface an image is presented on) and the ambient light sensing component can sense the changes in the photons. For example, the ambient light sensor can sense changes in ambient illumination caused by a variety of conditions including the amount and/or the actual direction of the ambient light photons that affect the environmental illumination of the presentation.

In one embodiment, an ambient light sensing component can sense the photogenic levels in multiple regions of space (e.g., around a display screen). For example, ambient light sensing component 110 can include multiple “spot” sensors (e.g., one in each of the four corners of a display) that sense different areas around a display (e.g., that correspond to different portions or sub-regions of the display). FIG. 1B is an illustration of image presentation system 150 comprising multiple light sensors 151, 152, 153 and 154 located in each of the corners of a display in accordance with one embodiment of the present invention. Ambient light measurements from the different regions of space around the display (e.g., from multiple “spot” sensors) can be averaged. The ambient light photogenic level measurements can also be averaged with respect to time (e.g., a number of measurements from a single sensor or multiple sensors over a predetermined period of time are averaged). In one exemplary implementation, an ambient light sensing component senses the ambient light in a subsection of an image (e.g., around a portion of a display). For example, an ambient light sensing component can sense and distinguish ambient light in a region smaller than the overall image display (e.g., based upon the spatial resolution capability of the sensor). FIG. 1C is an illustration of one embodiment of image presentation system 150 in which the light sensors sense ambient light in conical areas or spaces 171 through 174. The ambient light measurements obtained from each of the conical spaces 171 through 174 can be analyzed and compared to determine angle and intensity of the ambient light.

It is appreciated that the present invention is readily adaptable for varying orientations of ambient light sensing component 110. In one embodiment of the present invention, ambient light sensing component 110 can face out into the environment away form the display. For example, towards an anticipated user's viewing angle or vantage point with respect to the display. In another embodiment, ambient light sensing component 110 is directed towards the display. For example, a digital camera sensing component can face the display from a user's vantage point or from the orientation of another component associated with the display. In one exemplary implementation, an ambient light sensing component 110 is mounted in the keyboard of a lap top computer and oriented to face the screen. An ambient light sensing component can be configured to capture ambient light illumination measurements from the display face.

In one embodiment of the present invention, control component 120 adjusts the illumination of the image in response to changing lighting conditions. Control component 120 increases the display illumination for relatively dark ambient lighting conditions (e.g., increases the intensity of the back-light). Control component 120 decreases the display illumination for relatively light ambient lighting conditions (e.g. decreases the intensity of the back-light). The adjustment of the illumination can be based upon an average of ambient light measurements over different spatial regions and/or over a period of time. In an alternate embodiment, adjustments in the illumination of different portions of a display (e.g., sub-areas of the display) can be made to correspond with corresponding spatial region ambient light measurements. In one exemplary implementation, control component 120 provides illumination adjustment instructions to a back-light component 135. In an alternate implementation, control component 120 provides illumination adjustment instructions to a pixel generation component (not shown) and the illumination characteristics or values of the pixels are altered. In one embodiment of the present invention, control component 120 provides a feedback type adjustment of the display illumination.

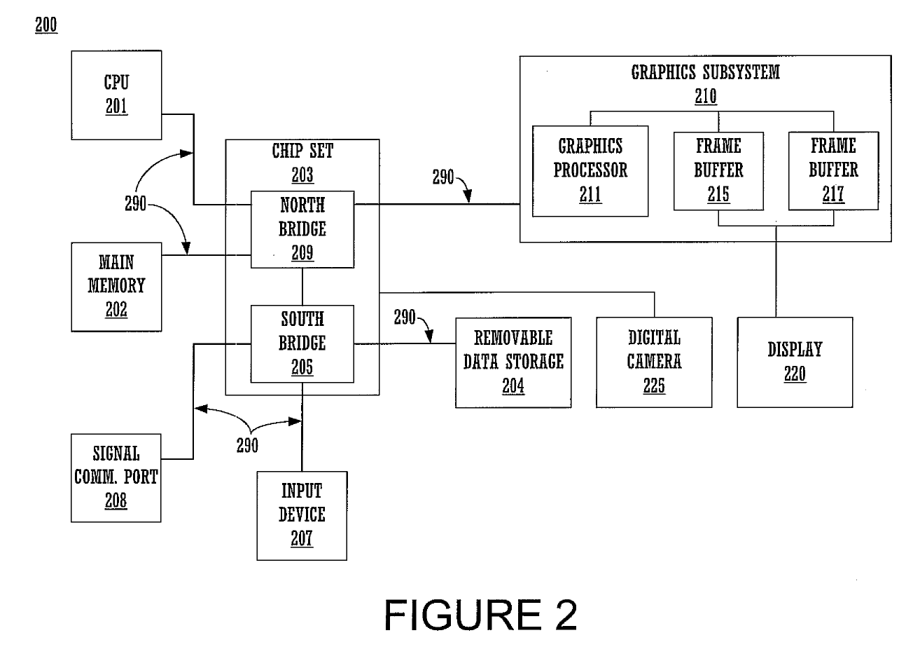

In one embodiment, the present invention is incorporated in a computer system. FIG. 2 is a block diagram of computer system 200, in accordance with one embodiment of the present invention. Computer system 200 includes communication bus 290, central processor unit 201, main memory 202 (e.g., random access memory), chip set 203 with north bridge 209 and south bridge 205, removable data storage device 204, input device 207, signal communications port 208, graphics subsystem 210, display 220 and digital camera 225. Communication bus 290 couples chipset 203 to central processor unit 201, main memory 202, removable data storage device 204, input device 207, signal communications port 208, digital camera 225 and graphics subsystem 210. Graphics subsystem 210 includes graphics processor 211 and graphics buffers 215 and 217. In one embodiment additional graphics buffers are provided to increase performance.

The components of computer system 200 cooperatively operate to provide a variety of functions, including processing of graphics information associated with an image and control of display illumination in response to changing ambient light conditions. Communications bus 290 communicates information, central processor 201 processes information and engages in display illumination control operations, main memory 202 stores information and instructions for the central processor 201. Removable data storage device 204 also stores information and instructions (e.g., functioning as a large information reservoir). For example, memories 202 and 204 store information that correlates image presentation adjustments to ambient light conditions, and processor 201 processes the information (e.g., compares information from the memories to input from digital camera 225) and issues instructions defining illumination adjustments. Digital camera 225 senses the ambient light conditions (e.g., around display device 209) and provides ambient light information to the system. Input device 206 provides a mechanism for inputting information and/or for pointing to or highlighting information on display 220. Signal communication port 208 provides a communication interface to exterior devices (e.g., an interface with a network). Display device 209 displays information in accordance with data stored in graphics buffers 215 and 217. Graphics processor 211 processes graphics commands from central processor 201 and provides the resulting data to graphics buffers 215 and 217 for storage and retrieval by display monitor 220.

Computer system 200 implements environmental responsive illumination adjustment measures during graphics operations. Central processor 201 receives input from digital camera 225 on the ambient illumination levels around display 220. In one embodiment, the memories of computer system 200 include graphics software control instructions that utilize real time ambient light measurements (e.g., provided by real time sampling techniques) and graphics software control instructions that direct corresponding image illumination optimization in real time. Central processor 201 utilizes the instructions from the memories and the input from digital camera 225 to develop and issue commands directed towards increasing or decreasing the illumination generated by a back-light in display 220 based upon the relative ambient light illumination measurements. In an alternate embodiment central processor 201 issues instructions to graphics subsystem 210 to increase or decrease the intensity of pixels in accordance with changing ambient light conditions. In yet another embodiment, graphics subsystem 210 (e.g., graphics processor 211) receives input from digital camera 225 and directs illumination adjustments.

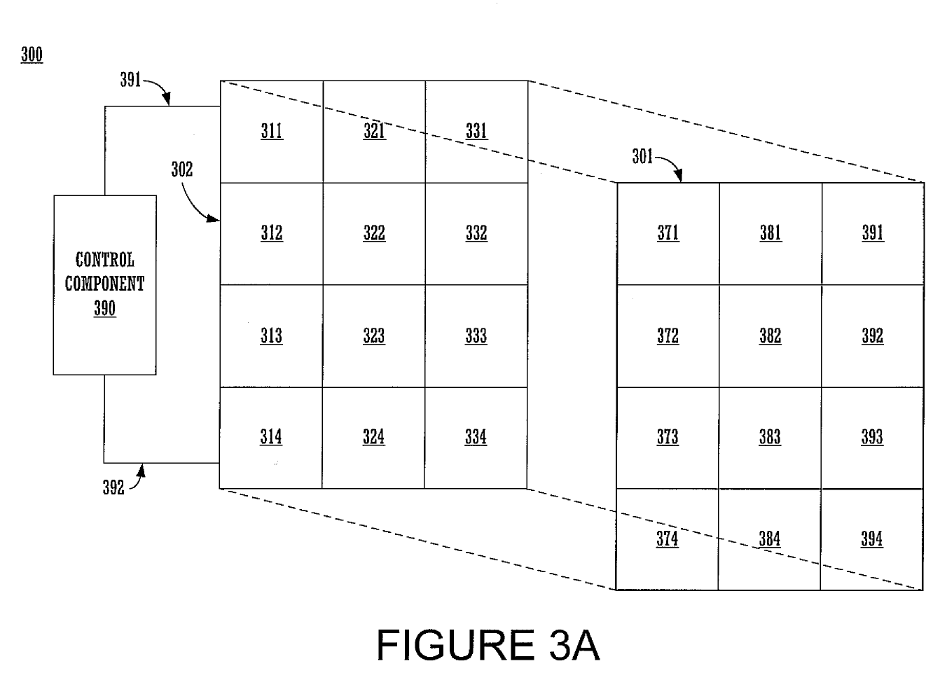

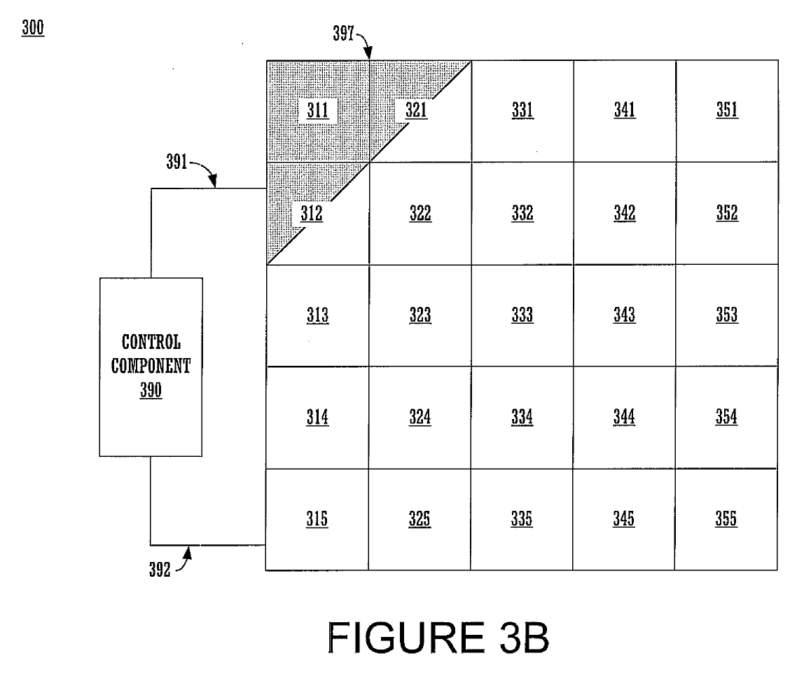

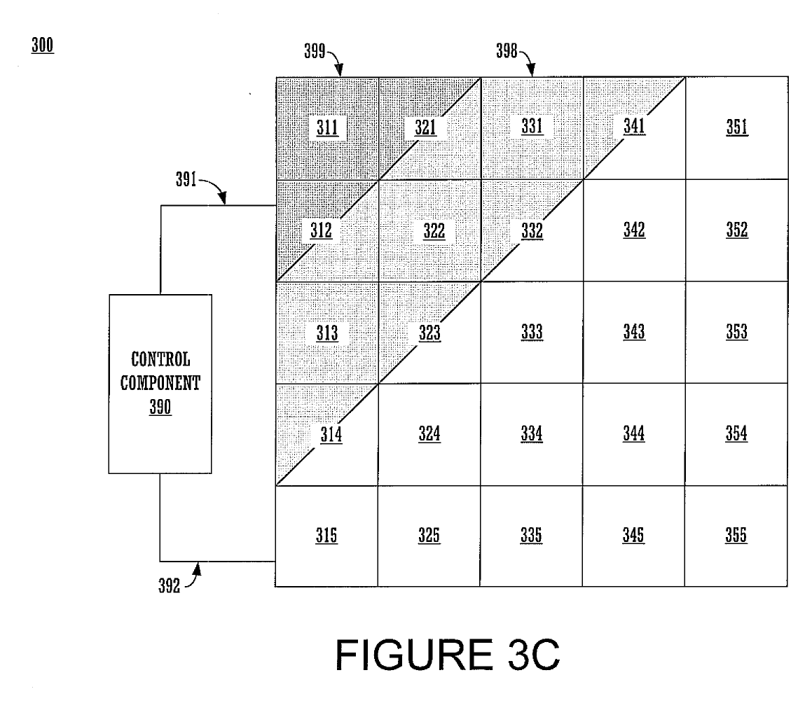

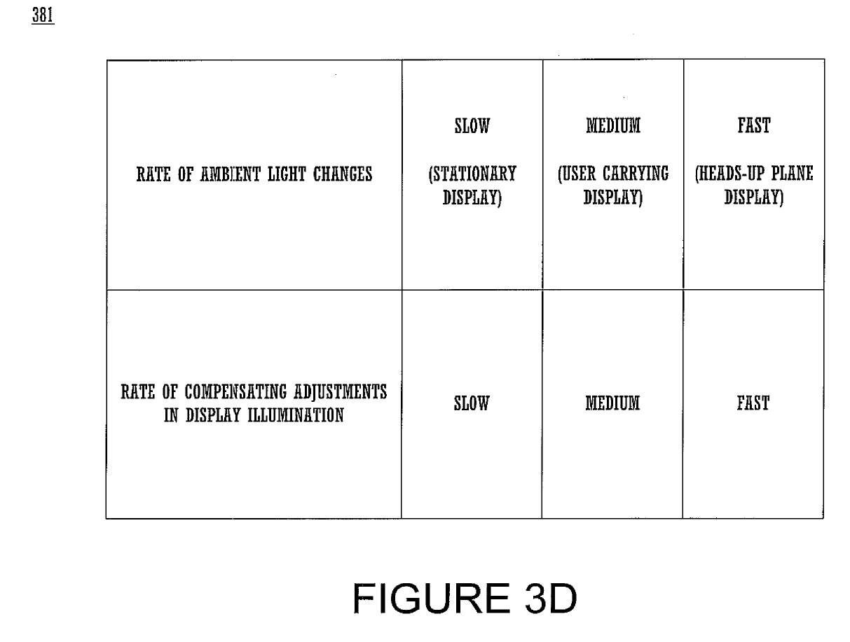

FIG. 3A is a block diagram of display presentation adjustment system 300, one embodiment of the present invention. Display presentation adjustment system 300 comprises display array 301, ambient light sensor array 302 and control component 390. Ambient light sensor array 302 is communicatively coupled to control component 390. Sensor array 302 comprises ambient light sensor components 311 through 334. Display array 301 comprises pixels 371 through 394. Sensor array 302 is located “behind” display array 301. Control component 390 provides pixel data adjustment instructions for illumination levels of pixel data associated with pixels 371 through 394. In one exemplary implementation, display array 301 is a display surface or screen upon which an image is presented for observation by a user. The surface or screen emits presentation light and permits ambient light to pass to sensor array 302 underneath.

The components of display presentation adjustment system 300 cooperatively operate to provide image presentations that adjust to compensate for changes in ambient lighting conditions. In one exemplary implementation, an image presentation is generated by impinging high-energy electrons on a picture element or “pixel” (e.g., pixels 371 through 394) of a phosphor screen and the phosphor converts the electron energy into visible light utilized to convey images to observers. Ambient light sensing components 311 through 334 sense ambient light that penetrates through the face of display array 310. The light sensing components convey information about the ambient light to control component 120. Control component 120 then directs adjustments to the pixel intensity of pixels 371 through 394 based upon the measured ambient light. In one embodiment, control component 120 directs a pixel intensity value generator (e.g., a graphics processor 211) to increase or decrease the pixel intensity values to compensate for ambient light measurements of relative darkness or lightness. Display device 300 can provide significant granularity in illumination adjustment. In one exemplary implementation, each pixel “above” (e.g., pixel 322) a light sensing component (e.g., ambient light sensing component 372) is adjusted based upon the input from that particular ambient light sensing component. In an alternate embodiment, several pixels are adjusted based upon input from a particular ambient light sensing component.

It is appreciated that the present invention is readily adaptable for use with a variety of display devices, including a cathode ray tube (CRT) display, a field emission display (FED), a vacuum fluorescent display (VFD), a plasma display panel (PDP), and/or an organic luminescent display (OEPLD). The image information is presented on the display screen in accordance with a fundamental “raster” display process or “pattern” that usually starts at the top of the display and goes across the display from left to right on each row and then drops to the row below until it reaches the bottom. Information on the brightness level for each primary color (e.g., red, blue and green) in a pixel is provided for each pixel included in the display. Pixels are arranged in a matrix of rows and columns in which each pixel has a unique identifier (e.g., row and column indicator). The display “illuminates” each pixel in accordance with illumination data assigned to a corresponding pixel identifier. The illumination data is adjusted to compensate for changes in ambient illumination.

FIG. 3B is one exemplary illustration of a shadow imposed upon display device without adjustment by the present invention. The shadow area 397 affects the presentation of an image by pixels 311, 312, and 321. FIG. 3C is another exemplary illustration of a shadow imposed upon display device without adjustment by the present invention. In one exemplary implementation, the different shadow regions 398 and 399 shown in FIG. 3C and the shadow region 397 in FIG. 3B are the result of changing ambient lighting conditions. It is appreciated that the area of a screen impacted by a shadow can change (e.g., the area covered by shadow region 397 versus the area covered by 398 and 399). It is also appreciated that different areas of the screen can be impacted by to a greater or lesser extent by a shadow (e.g., the area covered by region 398 is more impacted by a shadow than area 399). After adjustment in accordance with the present invention, the screen presents a uniform illumination as shown in FIG. 3A with respect to ambient lighting. It is understood that different pixels may have a different illumination for purposes of conveying the features (e.g., shape, motion, color, shading, etc.) of an image and the adjustments made in accordance with the present invention compensate for non-uniformity in ambient lighting.

The speed at which changes in ambient lighting occur impact the speed at which the compensating adjustments are made. For example, image presentation system 100, presentation adjustment system 300 or display presentation method 400 can be included in a portable device moving in a vehicle (e.g., a laptop computer, a heads-up display, etc.) and a shadow can be cast by something outside the vehicle (e.g., a building, a tree, another vehicle, etc.). The present invention facilitates adjustments in the presentation illumination to compensate for changes in ambient light conditions or shadow regions associated with respective positions changes of the vehicle and the other object (e.g., a building). FIG. 3D is a tabular representation 381 of one exemplary relationship between the rate at which ambient light conditions change and the rate at which compensating adjustments are made to the display. In the present example, the rate of ambient light changes corresponds to the velocity at which the display is moving (e.g., stationary PC or projection display, a handheld personal digital assistant being carried by a walking user, or a heads-up display in a plane). For example, if the device is stationary and changes in ambient light are slow the rate of compensating adjustment changes is also slow, whereas if the rate of changes in ambient light conditions is fast, the rate of compensating adjustment changes is also slow. It is also possible for the rate of ambient light changes to correspond to the velocity at which things which cast a shadow on the display are moving past the display. For example, even if a display is stationary and fast moving devices passing by the display are casting a shadow on the display which is also moving fast, the compensating adjustments are made at a relatively fast rate.

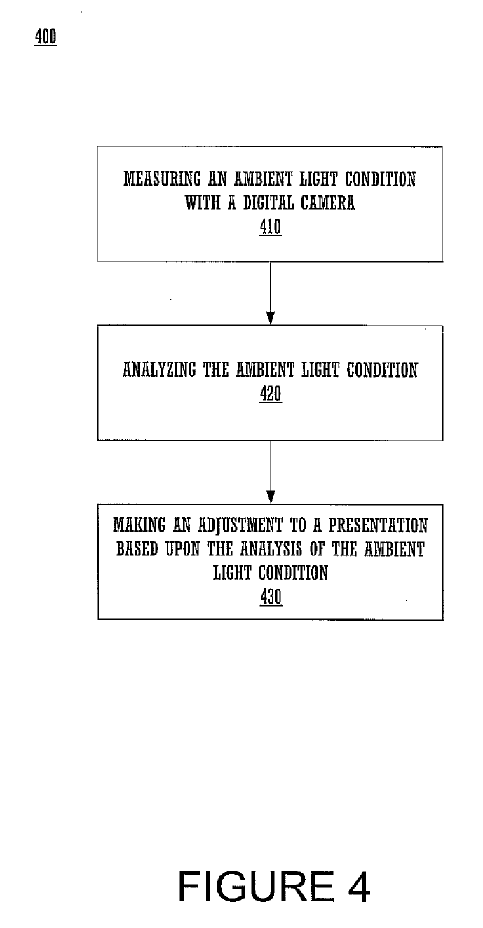

FIG. 4 is a flow chart of display presentation adjustment method 400, one embodiment of the present invention. In one exemplary implementation real time ambient light sampling input is utilized to calibrate the image presentation automatically. The present invention is able to calibrate the adjustments to make a rapid yet smooth transition in the presentation.

In step 410, an ambient light condition is measured (e.g., utilizing a digital camera). Ambient light measurements can be averaged over a period of time and/or from multiple measurement spots. For example, ambient light can be sampled or measured at a predetermined rate (e.g., 30, 60, etc. frames a second) or from different locations (e.g., four corners of a display). The measurements can be taken from a variety of orientations. The digital camera can be directed away from the display (e.g., towards the user) or the sensor can be directed towards the display (e.g., from an angle comparable to the users view).

In step 420, the ambient light condition is analyzed. In one embodiment of the present invention, the ambient light measurements are compared to a predetermined value (e.g., an optimal viewing illumination). If the measurements are lower than the predetermined value the analysis provides an indication to increase illumination intensity and if the measurements are higher than the predetermined value the analysis provides an indication to decrease the illumination. In one exemplary implementation, the ambient light condition is analyzed over a period of time and an average value is derived.

In step 430, an adjustment is made to a presentation based upon the analysis of the ambient light condition. For example, the illumination provided by a back-light is increased if the ambient light analysis indicates there is insufficient ambient light for optimal viewing. The adjustment can be made based upon an average of those readings (e.g., an average of ambient light measurements over time and/or space). In one exemplary implementation, the adjustment is made to pixel data and/or back-lighting of a display device. In one exemplary implementation, control directions are issued to a pixel intensity value generator (e.g., graphics processor 211) to increase or decrease the pixel intensity values (e.g., stored in a graphics buffer) to compensate for ambient light measurements of relative darkness or lightness. For example, essentially overlaying an intensity adjusting vertex map on the display image.

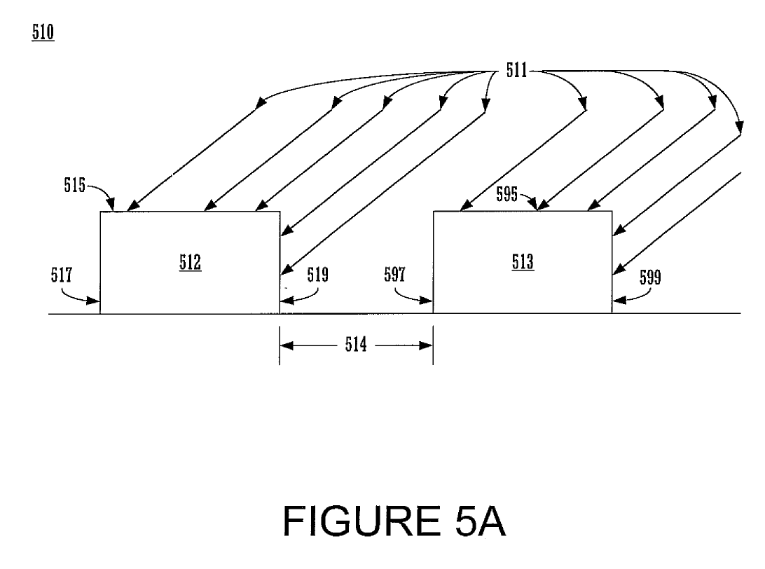

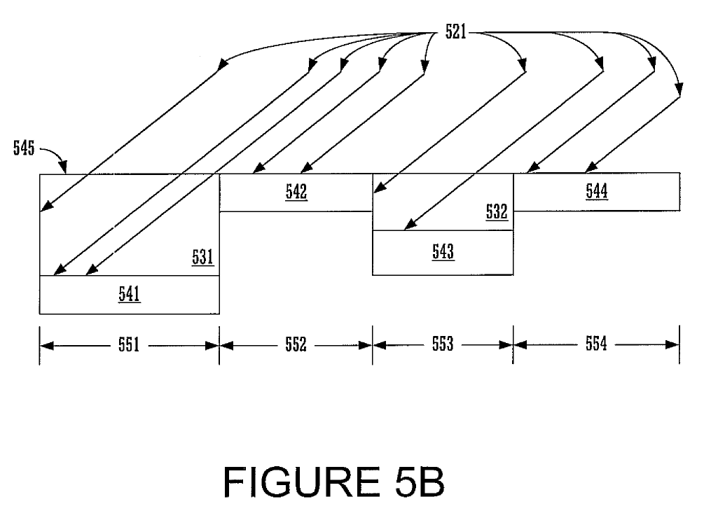

It is appreciated that a sensor for obtaining ambient lighting measurements for utilization by the present invention can have a variety of different configurations. FIG. 5A is an illustration of one exemplary configuration of light sensors 512 and 513 which are a distance 514 apart. Light sensor 512 can sense light on 515, 517 and 519. Light sensor 513 can sense light on sides 595, 597 and 599. By comparing the relative intensity of light sensing on the different sides of light sensors 512 and 513 the a display presentation adjustment system and method of the present invention can determine the movement and angular characteristics of the ambient light. It is appreciated the length and height of light sensors 512 and 513 can vary. FIG. 5B is an illustration of another exemplary configuration of present invention sensors. Light sensors 514 and 543 are located at the bottom of wells 531 and 532 while sensors 542 and 544 are located on surface 545. Again the widths 551, 552, 553 and 554 of the light sensors 541, 542 5432 and 544 respectively can vary. The depths of the wells 531 and 532 can also vary. Again by measuring the intensity of light at the varying light sensor points a present invention display presentation adjustment system and method can determine the movement and angular characteristics of the ambient light. In one embodiment of the present implementation the side walls of wells 531 and 532 can also have light sensors.

It is appreciated that the present invention systems and methods can be implemented in a variety of devices. For example the present invention systems and methods can be implemented in computer systems, game consoles, graphics systems, laptops, televisions (TVs), personal digital assistants (PDAs), projectors, cell phones, digital video cameras, personal video players, arcade systems, display or presentation devices in a vehicle (e.g., a car, plane, etc.), and headsup display devices.

Thus, the present invention provides a flexible and efficient system and method for adjusting the illumination of an image display with compensation for ambient lighting conditions. By adjusting the presentation (e.g., adjusting back-lighting and/or pixel data), the present invention provides an improved image quality as the ambient lighting conditions change and also facilitates power conservation (e.g., by reducing back-lighting when not required). The present invention facilitates a higher quality visual experience in which a user more readily see an image in an environment with changing ambient lighting conditions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An image presentation system comprising:
a digital camera sensing component for capturing a picture and sensing ambient light conditions on an image, wherein measurements of said ambient light conditions are taken in a direction towards said image from an angle comparable to a user's view; and
a control component for adjusting said image based upon said ambient light condition.

2. An image presentation system of claim 1 further comprising a display component for displaying said image.

3. An image presentation system of claim 1 wherein said digital camera sensing component measures ambient light illumination comprising photons that strike said image and said protons are provided from a source other than said image presentation system.

4. An image presentation system of claim 1 wherein said digital camera is oriented to sense ambient light with respect to a user viewing direction.

5. An image presentation system of claim 1 wherein said control component comprises:
a memory for storing information associated with correlating image presentation adjustments to ambient light conditions and graphics control software instruction that direct said display illumination adjustments; and
a processor for processing said information and issuing instructions defining said adjustments.

6. An image presentation system of claim 1 wherein said digital camera sensing component and said control component are included in a mobile device.

7. A display presentation adjustment method comprising:
measuring an ambient light condition with a digital camera, wherein measurements are taken in a direction towards the display from an angle comparable to a user's view;
analyzing said ambient light condition; and
making an adjustment to a presentation based upon said analysis of said ambient light condition.

8. The display presentation adjustment method of claim 7 wherein said adjustment comprises adjusting pixel data.

9. The display presentation adjustment method of claim 7 wherein said adjustment comprises adjusting back-lighting of a display device.

10. The display presentation adjustment method of claim 7 wherein said analyzing comprises averaging a number of sensor measurements over time.

11. The display presentation adjustment method of claim 7 wherein measurements are taken from a variety of orientations.

12. The display presentation adjustment method of claim 7 wherein measurements are taken in a direction away from the display towards a user.

13. The display presentation adjustment method of claim 7 wherein said measurements of said ambient light condition comprises measurements of photons that strike a display and said protons are provided from a source other than said display.

14. The display presentation adjustment method of claim 7 wherein measurements of said ambient light condition are compared to a predetermined value.

15. A display presentation adjustment system comprising:
a bus for communicating information;
a processor for receiving input on ambient illumination level around a display and making display illumination adjustments based upon a relative ambient light illumination measurement, wherein said ambient light illumination measurement is taken in a direction towards the display from an angle comparable to a user's view; said processor coupled to said bus; and
a memory that includes graphics software control instructions that direct said display illumination adjustments; said memory coupled to said bus.

16. A display presentation adjustment system of claim 15 wherein said memory stores information that provides a correlation between ambient light conditions and said image presentation adjustments.

17. A display presentation adjustment system of claim 15 wherein said instructions for directing said display illumination adjustments utilize real time ambient light measurements and provide control of said display illumination adjustments in real time.

18. A display presentation adjustment system of claim 15 wherein said processor is a graphics processing unit (GPU).

19. A display presentation adjustment system of claim 15 wherein said processor is a central processing unit (CPU).

20. A display presentation adjustment system of claim 15 further comprising a digital camera for sensing the ambient light conditions and providing ambient light information to said memory and said processor, said digital camera coupled to said bus.

21. The display presentation adjustment method of claim 15 further comprising a graphics buffer wherein pixel illumination values in said graphics buffer are increased or decreased by a predetermined amount, said graphics buffer coupled to said bus.

22. The display presentation adjustment method of claim 15 further comprising a backlighting system wherein illumination generated by said backlighting system are increased or decreased by a predetermined amount, said backlighting system coupled to said bus.

23. A display presentation adjustment system of claim 15 further comprising a sensor array behind a display screen for sensing ambient light conditions and providing ambient light information to said memory and said processor, said sensor array coupled to said bus.
